(19) United States
(12) Patent Application Publication
(10) Pub. No.: US 2001/0036172 A1
(43) Pub. Date: Nov. 1, 2001

(54) Wireless voice over internet protocol communication systems

(76) Inventor: Aaron Haskal, Rolling Hills Estates, CA (US)

Correspondence Address: David S. Sarisky, Esq., FULWIDER PATTON LEE & UTECHT, LLP, Tenth Floor, 6060 Center Drive, Los Angeles, CA, 90045, US

(21) Appl. No.: 09/771,319

(22) Filed: Jan. 26, 2001

Related U.S. Application Data
(60) Provisional application No. 60/180,016, filed on Feb. 3, 2000.

(51) Int. Cl. H04L 12/66

(52) U.S. Cl. 370/352; 370/329; 370/401

(57) ABSTRACT

A source communication system and destination communication system communicate over an IP packet-switched data network through a pair of interface devices and gateways. In operation, a wireless source telephone converts voice signals to voice data packets in a specified format. The voice data packets are routed through a source switching device to a source interface device. The source interface device reformats the voice data packets to a format compatible with the communications protocol used by the IP packet-switched data network. A source gateway receives the reformatted voice data packets and routes the reformatted voice data packets over the IP packet-switched network to a destination gateway. The destination gateway routes the reformatted voice data packet to a destination interface device which, in turn, reformats the reformatted voice data packets to the specified format and outputs the re-reformatted voice data packets to the destination system. A wireless destination telephone converts the voice data packets to sound.

### RELATED APPLICATION

This application claims the benefit of provisional application serial No. 60/180,016 filed on Feb. 3, 2000.

### BACKGROUND OF THE INVENTION

1. Field of the Invention

The invention relates generally to voice over Internet protocol (VoIP) communications systems and more particularly to communications systems for, and methods of, transmitting wireless cellular or personal communications services (PCS) voice data packets from a source system to a destination system over an Internet protocol (IP) packet-switched data network.

2. Description of Related Art

Typically, a telephone call from a source cellular telephone to another remotely located destination cellular telephone or plain old telephone system (POTS) land-line telephone is placed over a communications system using a circuit-switched public switched telephone network (PSTN), such as shown in FIG. 1. Source cell telephone A, located for example in Los Angeles, places a long distance call to destination cell telephone B, located in New York. Cell telephone A dials 1 plus the area code, e.g. 212, plus the destination number. The digital voice data comprising the call is transmitted via RF to a transceiver/base station and then to a mobile telephone switching office (MTSO). At the MTSO the digital voice data is converted to a 64 kilobits format compatible with the analog circuit switching network used by local central offices (C/O) and the PSTN.

From the MTSO, the voice data travels via a voice T1 line to a local or nearest C/O, to an interexchange carrier switch (not shown), and then to the PSTN. Within the PSTN, the voice data is routed to the local C/O in New York. If the destination telephone is a land-line telephone (not shown) the local C/O routes the voice data to the land-line telephone. If the destination telephone is a cellular telephone the local C/O routes the voice data to a destination MTSO. The destination MTSO converts the 64 kilobits back to a voice data packet and sends it to the destination transceiver/base station, which in turn transmits it via RF to the destination cell telephone B.

Utilization has been made recently of the Internet to place long distance calls in an IP packet-switched format from one land-based personal computer (PC) to another. In such a system the voice call is digitized and formatted into IP packets and routed from the IP address of the source PC to the IP address of the destination PC where it is reassembled. Communication over such systems, however, requires the use of PCs.

U.S. Pat. No. 5,953,322, describes a cell telephone that provides the capability of placing Internet-based calls by using the vocoders already present in the cell telephone for IP packetization of the voice signal. The '322 patent recognizes that the IP packetization of voice for suitable transmission as a VoIP call may be accomplished by the hardware and software in a specially configured digital cell telephone. The cell telephone generates an IP packet that carries the digital call data and encapsulates the IP packet into a payload. The cell telephone transmits the IP packet to a base station. If the payload contains the IP packet, the base station extracts the IP packet and transfers it over the Internet. This system, however, only allows for such wireless VoIP calls to be placed from a cell telephone that is specially adapted to allow such calls. That is, one must have this specially configure cell telephone in order to place a wireless VoIP using the system described in the patent.

Hence those skilled in the art have recognized the need for a communications system that allows for any standard wireless cellular or PCS telephone to place calls over an IP packet-switched data network to thereby eliminate the use of the circuit-switched long distance telephone network. The present invention fulfills this need and others.

### SUMMARY OF THE INVENTION

Briefly, and in general terms, the invention relates to VoIP communications systems and more particularly, to communications systems for, and methods of, transmitting wireless cellular or PCS voice data packets from a source system to a destination system over an IP packet-switched data network using a specified communications protocol.

In one aspect, the invention relates to a communications system that includes a source interface device adapted to receive voice data packets, of a specified format, from the source system and reformat the voice data packets to a format compatible with the specified communications protocol used by the IP packet-switched data network. The system also includes a source gateway adapted to receive the reformatted voice data packets from the source interface device and to route the reformatted voice data packets over the IP packet-switched network to a destination gateway. The destination gateway is adapted to route the reformatted voice data packet to a destination interface device which, in turn, is adapted to reformat the reformatted voice data packets to the specified format and output the re-reformatted voice data packets to the destination system.

By positioning interface devices between both the source system and the destination system and their respective source gateway and destination gateway and adapting these devices to—on the source side—reformat voice data packets to a format compatible with the IP packet switched data network and—on the destination side—re-reformat the voice packet data to its original format, the system allows a wireless cellular or PCS telephone, employing any standard data platform, to place a call over an IP packet-switched network worldwide without having to use a circuit-switched long distance telephone network.

In detailed facets of the system, the IP packet-switched data network comprises any one of the public Internet or private data networks using any one of several underlying transport technologies including Frame Relay, asynchronous transfer mode (ATM), Ethernet, Gigabit Ethernet and digital subscriber lines (DSL). In another detailed aspect, the specified communication protocol is TCP/IP and the specified format comprises any one of global system for mobile communications (GSM) services, code-division multiple access (CDMA), time-division multiple access (TDMA), frequency division multiple access (FDMA), advanced mobile phone service (AMPS), and digital advanced mobile phone service (D-AMPS). In yet another detailed aspect, the source system includes a wireless source telephone adapted to convert voice signals to voice data packets in the specified format. The data packets include data indicating a call type, which may comprise local calls and long distance calls. The source system further includes a source switching device that is adapted to receive the voice data packets, recognize the call type, and forward the voice data packets to the destination interface device only for a specified call type. In a more detailed aspect of the system, the specified call type is a long distance call. In another detailed facet of the system, the destination system includes a wireless destination telephone, a destination switching device adapted to receive the re-reformatted voice data packets from the destination interface device and a destination transceiver/base station adapted to receive the re-reformatted voice data packets from the destination switching device and to transmit the re-reformatted voice data packets to the wireless destination telephone.

In another aspect, the invention relates to a communications system that includes a source gateway adapted to receive the voice data from a source system, convert the voice data into voice data packets compatible with the specified communications protocol and route the voice data packets over the IP packet-switched network. The system further includes a destination gateway adapted to receive the voice data packets from the source gateway over the IP packet-switched network, convert the voice data packets into voice data and route the voice data to a destination system.

By positioning a source gateway and a destination gateway between an IP packet-switched data network and their respective source and destination systems and adapting the source gateway to convert voice data to voice data packets for transport over the data network and adapting the destination gateway to convert the voice data packet back to voice data, the system allows a call placed from a wireless telephone to bypass the PSTN and the associated interexchange carrier switches used by long distance companies.

In a detailed aspect the source system includes a source circuit-switched data network and a wireless source telephone adapted to convert voice signals to voice data packets, of a specified format. The voice data packets include data indicating a call type. The source system further includes a source switching device adapted to receive the voice data packets from the wireless source telephone and convert the voice data packets to a circuit-switched format compatible with the circuit-switched data network. The circuit-switched data network is adapted to recognize the call type and to route the voice data to the source gateway only for a specified call type. In another detailed facet, the destination system includes a wireless destination telephone and a destination circuit-switched data network adapted to receive the voice data from the destination gateway and to route the voice data to a destination switching device. The destination switching device is adapted to reformat the voice data into the specified voice data packet format.

In another aspect, the invention relates to a method of transmitting voice data packets from a source system to a destination system over an IP packet-switched data network using a specified communications protocol. The method includes reformatting voice data packets, of a specified format, received from the source system to a format compatible with the specified communications protocol. The method further includes routing the reformatted voice data packets over the IP packet-switched network to a point near the destination system, reformatting the reformatted voice data packets to the specified format and routing the re-reformatted voice data packets to the destination system.

These and other features and advantages of the invention will become apparent from the following detailed description and the accompanying drawings which illustrate by way of example the features of the invention.

### BRIEF DESCRIPTION OF THE DRAWINGS

FIG. 1 is block diagram of a typical circuit-switched PSTN system used with a cellular telephone call;

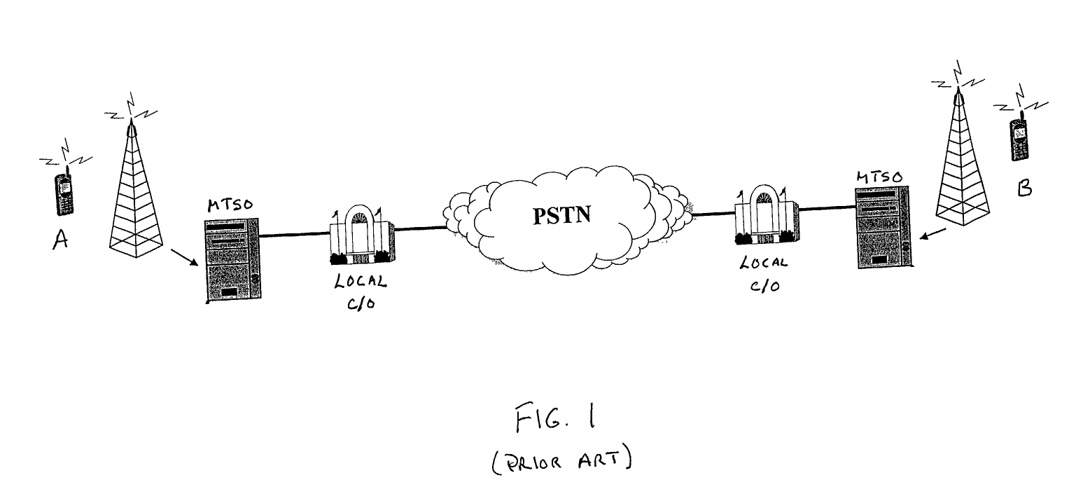

FIG. 2 is a block diagram of a communication system in accordance with one aspect of the present invention, employing gateways to send voice data packets over an IP packet-switched data network; and

FIG. 3 is a block diagram of a communications system in accordance with another aspect of the invention, employing interface devices and gateways to send voice data packets over an IP packet-switched data network.

### DETAILED DESCRIPTION OF THE PREFERRED EMBODIMENTS

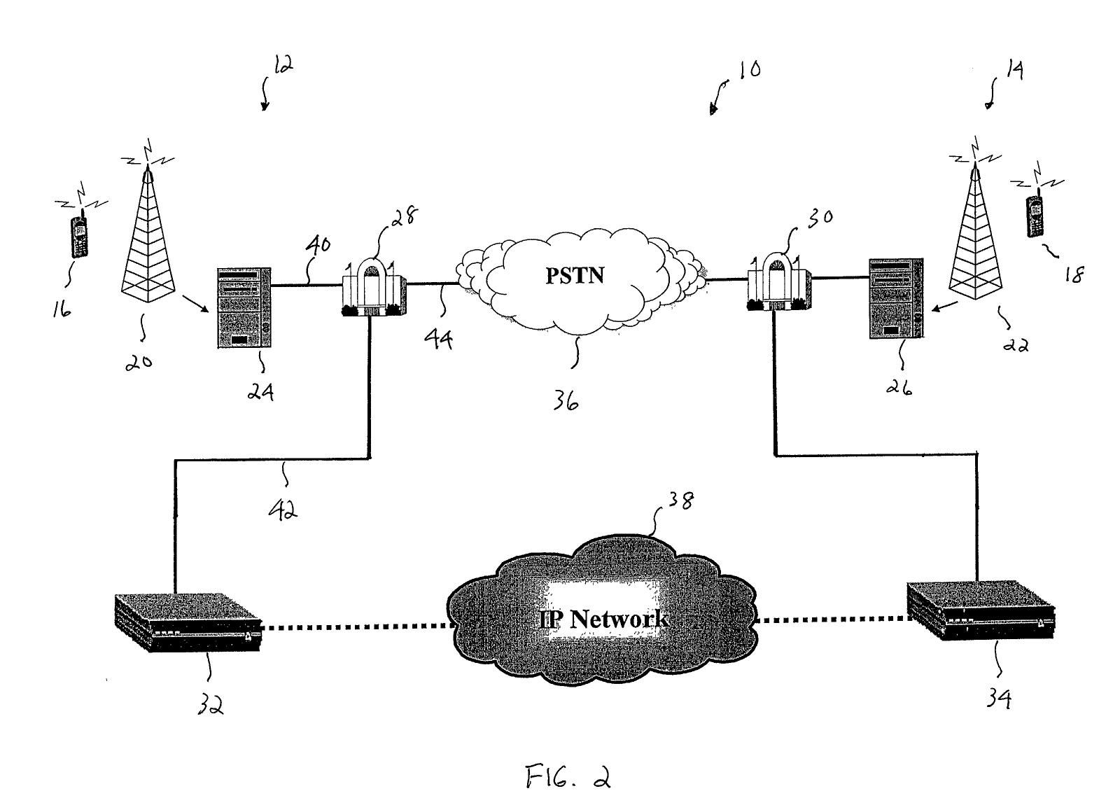

Turning now to the drawings, in which like reference numerals are used to designate like or corresponding elements among the several figures, in FIG. 2 there is shown a communications system 10 configured in accordance with aspects of the present invention. The system 10 includes a source side 12 and a destination side 14. Each of the source side 12 and the destination side 14 include a source system and destination system respectively, each of which includes a wireless telephone 16, 18, a transceiver/base station 20, 22, a MTSO 24, 26, and a local C/O 28, 30. Each of the source and destination sides further include a gateway 32, 34. The local C/Os 28, 30 of the source side 12 and the destination side 14 communicate over a PSTN 36, while the gateways 32,34 communicate through a data network 38. The data network 38 may be the public Internet or a private data network that operates using any one of several underlying transport technologies including Frame Relay, ATM, Ethernet, Gigabit Ethernet and DSL.

In operation, a user places a call using the source telephone 16 which operates in conjunction with an analog or digital-based cellular service, such as, but not limited to, cellular and PCS services. During the call, the microphone subsystem within the source telephone 16 senses audio input and converts the audio input into electrical signals. These electrical signals are converted by the telephone vocoder into compressed digital audio samples in accordance with the underlying platform of the service, e. g., GSM, CDMA, TDMA, FDMA, AMPS, and D-AMPS, and assembled into voice data packets for transmission by the source transceiver/base station 20. Included in the voice data packets is the destination number, i. e., the telephone number the user is calling.

The source transceiver/base station 20 forwards the packetized voice data to the source MTSO 24. The MTSO 24 converts the voice data packet to a data format compatible with the source local C/O 28 and the PSTN 36. This format is typically a 64 kilobit circuit-switched format. The converted voice data is sent to the source local C/O 28 over a channelized T1 line 40 capable of handling voice data. The source local C/O 28 reviews the destination number contained in the converted voice data to determine the call type, e. g., local or long distance. If the destination number is prefixed with a “1”, the call type is long distance and the source local C/O 28 routes the converted voice data to the source gateway 32 over a channelized T1 line 42. If the destination number is local, the local C/O 28 routes the converted voice data to the PSTN 36 over a channelized T1 line 44.

Continuing with a long distance call type, at the source gateway 32 the converted voice data is formatted into a format compatible with the communications protocol of the data network 38, which in most cases is a TCP/IP protocol. Using the destination data contained within the formatted voice data packet, the source gateway 32 routes the formatted voice data packet over the data network 38 to the destination gateway 34 near the destination.

The destination gateway 34 receives the formatted voice data packet and converts it back to its original 64 kilobit, circuit-switched format. The destination gateway 34 outputs the re-converted voice data to the destination local C/O 30. Using a routing table, the destination local C/O 30 recognizes the destination number as either a land-line destination or a wireless destination. If the destination is land line, the destination local C/O 30 routes the re-converted voice data to the destination land-line telephone (not shown).

If the destination is a wireless device, the destination local C/O routes the re-converted voice data to the destination MTSO 26. The destination MTSO 26 converts the 64 kilobit voice data to a voice data packet compatible with the destination wireless telephone 18. The destination MTSO 26 forwards the voice data packet to the destination transceiver/base station 22 for RF transmission to the wireless destination telephone 18. The destination telephone then extracts and decompresses the digital audio samples contained within the payloads of the incoming voice data packet and provides the audio samples to the telephone speaker for rendering to the caller.

By utilizing the communication system of FIG. 2, a call place from a wireless telephone can bypass the PSTN and the associated interexchange carrier switches used by long distance companies and instead be transported over a data network, such as the Internet, thereby eliminating long distance toll charges.

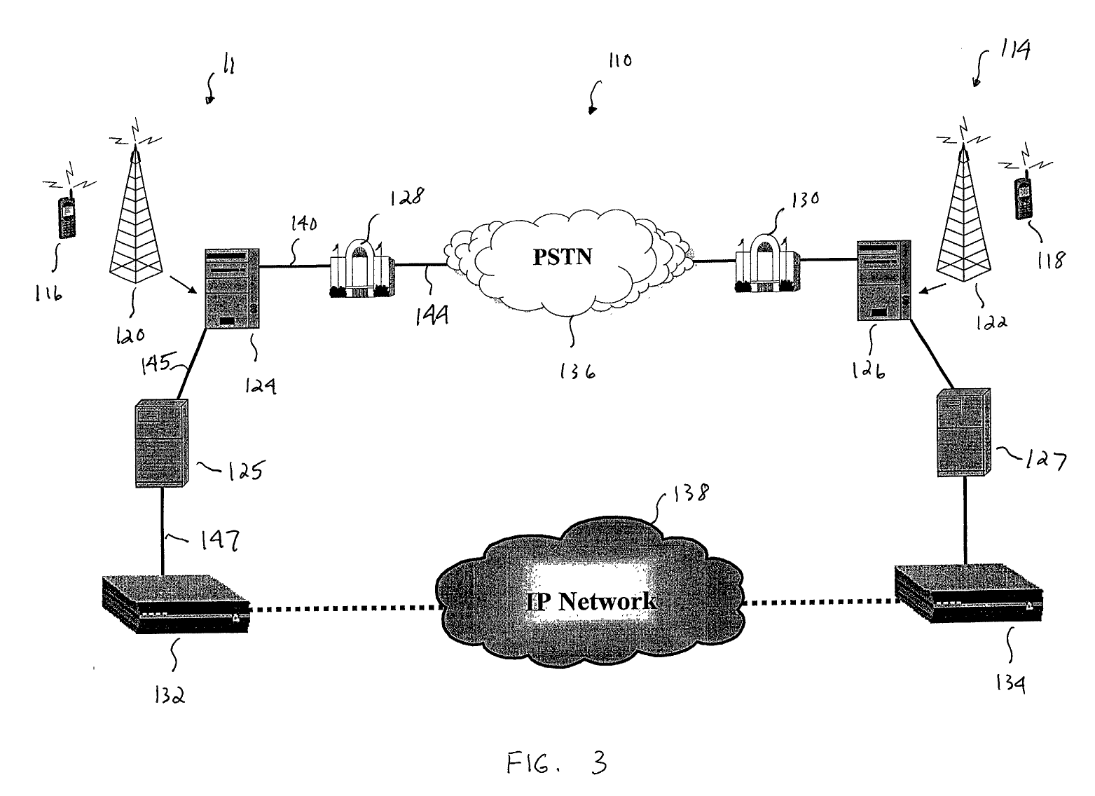

With reference to FIG. 3, in another embodiment of the invention, a communications system 110 includes a source side 112 and a destination side 114. Each of the source side 112 and the destination side 114 include a source system and destination system respectively, each of which includes a wireless telephone 116, 118, a transceiver/base station 120, 122, a MTSO 124, 126, and a local C/O 128, 130. Each of the source side 112 and the destination side 114 further include an interface device 125, 127 and a gateway 132, 134. Although the interface devices 125, 127 are shown as separate components, the processes performed by the devices, as described herein, may be implemented in a programmable digital circuit card. This circuit card may be installed in the MTSO 124, 126 or other cellular/PCS mobility switch.

The local C/Os 128, 130 of the source side 112 and the destination side 114 communicate through a PSTN 136, while the gateways 132, 134 communicate through a data network 138. As with the first configuration of the invention, the data network 38 may be the public Internet or a private data network that operates using any one of Frame Relay, ATM, Ethernet, Gigabit Ethernet and DSL.

In operation a user places a call using the source telephone 116 operating in conjunction with an analog or digital-based cellular service, such as, but not limited to, cellular and PCS services. During the call, the microphone subsystem within the telephone senses audio input and converts the audio input into electrical signals. These electrical signals are converted by the telephone vocoder into compressed digital audio samples in accordance with the underlying platform of the service, e. g., GSM, CDMA, TDMA, FDMA, AMPS, and D-AMPS, and assembled into voice data packets for transmission by the source transceiver/base station 120. Included in the voice data packets is the destination number, i. e., the telephone number the user is calling.

The source transceiver/base station 120 forwards the voice data packets to the source MTSO 124. The source MTSO 124 reviews the destination number contained in the voice data packet to determine the call type. If the destination is local, the source MTSO 124 converts the voice data packet to a data format compatible with the source local C/O 128 and the PSTN 136. This format is typically a 64 kilobit circuit-switched format. The converted voice data is sent to the source local C/O 128 over a channelized T1 line 140. The source local C/O 128 then routes the converted voice data to the PSTN 136 over a channelized T1 line 144.

If the destination number is prefixed with a “1”, the call type is long distance. In this case the source MTSO 124 does not convert the voice data packet to a 64 kilobit circuit-switched format, but instead routes the voice data packet over an unchannelized T-1 line 145, capable of handling packet data, to the source interface device 125. The source interface device 125 receives the voice data packet, recognizes the underlying platform of the voice data packet, e. g., GSM, CDMA, TDMA, FDMA, AMPS, D-AMPS, etc., and reformats the voice data packet into a format compatible with the communications protocol of the data network 138, which in most cases is a TCP/IP protocol.

The source interface device 125 outputs the reformatted voice data packet to the source gateway 132 over another unchannelized T1 line 147. Using the destination data contained within the reformatted voice data packet, the source gateway 132 routes the reformatted voice data packet over the data network 138 to the destination gateway 134 near the destination.

The destination gateway 134 receives the reformatted voice data packet and forwards it to the destination interface device 127. The destination interface device 127 recognizes the underlying platform of the source call and reformats the voice data packet back into its original format. The destination interface device 127 outputs the re-reformatted voice data packet to the destination MTSO 126. Using a routing table, the destination MTSO 126 recognizes the destination number as either a land-line destination or a wireless destination.

If the destination is land-line, the destination MTSO 126 converts the re-reformatted voice data packet to 64 kilobit format and transmits it to a destination local C/O 130 where it is routed to the destination land-line telephone (not shown). If the destination is a wireless device, the destination MTSO 126 forwards the re-reformatted voice data packet to the destination transceiver/base station 122 for RF transmission to the wireless destination telephone 118. The destination telephone then extracts and decompresses the digital audio samples contained within the payloads of the incoming re-reformatted voice data packet and provides the audio samples to the telephone speaker for rendering to the caller.

By using the communications system of FIG. 3, a wireless cellular or PCS telephone, employing any standard data platform, e. g., GSM, TDMA, CDMA, GSM, AMPS, D-AMPS, may place a call over an IP packet-switched network, such as the public Internet or private data networks, using any one of several underlying transport technologies including Frame Relay, ATM, Ethernet, GigaBit Ethernet and DSL, worldwide without having to use a circuit-switched long distance telephone network. The MTSOs 124, 126 and interface devices 125, 127 divert long distance calls directly to the gateways 132, 134, thereby bypassing the need to rout the call via the PSTN.

The communications system of FIG. 3 also provides a better quality voice call, in that a digital cell call starting out as a digital packet call remains a digital packet call through the entire communications process. There is no need to convert the digital packet call to 64 kilobits to match the PSTN analog circuit-switched network and then to convert it back to a digital format, a process that inevitably leads to loss of voice quality.

Although the communications system thus described relates generally to the transmission and receipt of voice data, the system may also be used to transmit other electronic data, such as data transmitted using wireless application protocol (WAP), e. g., Internet access data, etc. The high speed data transmission rate provided by the pure IP data packet operation of the system lends itself to WAP and thereby provides an alternative to cellular digital packet data (CDPD) based systems.

It will be apparent from the foregoing that while several particular forms of the invention have been illustrated and described, various modifications can be made without departing from the spirit and scope of the invention. Accordingly, it is not intended that the invention be limited, except as by the appended claims.

What is claimed is:

1. A communications system for transmitting voice data packets from a source system to a destination system over an IP packet-switched data network using a specified communications protocol, said system comprising:
a source interface device adapted to receive voice data packets, of a specified format, from the source system and to reformat voice data packets to a format compatible with the specified communications protocol; and
a source gateway adapted to receive the reformatted voice data packets from the source interface device and to route the reformatted voice data packets over the IP packet-switched network to a destination gateway;
wherein the destination gateway is adapted to route the reformatted voice data packet to a destination interface device adapted to reformat the reformatted voice data packets to the specified format and to output the re-reformatted voice data packets to the destination system.

2. The system of claim 1 wherein the IP packet-switched data network comprises any one of the public Internet and private data networks using any one of Frame Relay, ATM, Ethernet, Gigabit Ethernet and DSL as a transport technology and the specified communication protocol is TCP/IP.

3. The system of claim 1 wherein the specified format comprises any one of GSM, CDMA, TDMA, FDMA, AMPS and D-AMPS.

4. The system of claim 1 wherein the source system comprises:
a wireless source telephone adapted to convert voice signals to voice data packets in the specified format, the data packets including data indicating a call type; and
a source switching device adapted to receive the voice data packets, to recognize the call type, and to forward the voice data packets to the destination interface device only for a specified call type.

5. The system of claim 4 wherein the call types comprise local calls and long distance calls and the specified call type is a long distance call.

6. The system of claim 4 wherein the source system further comprises a source transceiver/base station for transmitting the voice data packets form the wireless source telephone to the source switching device.

7. The system of claim 1 wherein the destination system comprises:
a wireless destination telephone;
a destination switching device adapted to receive the re-reformatted voice data packets from the destination interface device; and
a destination transceiver/base station adapted to receive the re-reformatted voice data packets from the destination switching device and to transmit the re-reformatted voice data packets to the wireless destination telephone.

8. A method of transmitting voice data packets from a source system to a destination system over an IP packet-switched data network using a specified communications protocol, said method comprising:
reformatting voice data packets, of a specified format, received from the source system to a format compatible with the specified communications protocol;
routing the reformatted voice data packets over the IP packet-switched network to a point near the destination system;
reformatting the reformatted voice data packets to the specified format and
routing the re-reformatted voice data packets to the destination system.

9. A communications system for transmitting voice data from a source system to a destination system over an IP packet-switched network having a specified communications protocol, said system comprising:
a source gateway adapted to receive the voice data from the source system, to convert the voice data into voice data packets compatible with the specified communications protocol and to route the voice data packets over the IP packet-switched network; and
a destination gateway adapted to receive the voice data packets from the source gateway over the IP packet-switched network, to convert the voice data packets into voice data and to route the voice data to the destination system.

10. The system of claim 9 wherein the source system comprises:
a source circuit-switched data network;
a wireless source telephone adapted to convert voice signals to voice data packets, of a specified format, the voice data packets including data indicating a call type; and
a source switching device adapted to receive the voice data packets from the wireless source telephone, to convert the voice data packets to a circuit-switched format compatible with the circuit-switched data network;
wherein the circuit-switched data network is adapted to recognize the call type and to route the voice data to the source gateway only for a specified call type.

11. The system of claim 10 wherein the call types comprise local calls and long distance calls and the specified call type is a long distance call.

12. The system of claim 10 wherein the source system further comprises a source transceiver/base station for transmitting the voice data packets form the wireless source telephone to the source switching device.

13. The system of claim 1 wherein the destination system comprises:
a wireless destination telephone; and
a destination circuit-switched data network adapted to receive the voice data from the destination gateway and to route the voice data to a destination switching device;
wherein the destination switching device is adapted to reformat the voice data into the specified voice data packet format.

14. The system of claim 14 wherein the destination system further comprises a destination transceiver/base station adapted to receive the reformatted voice data packets from the destination switching device and to transmit the reformatted voice data packets to the wireless destination telephone.
